(19) United States
(12) Patent Application Publication
(10) Pub. No.: US 2006/0127799 A1
(43) Pub. Date: Jun. 15, 2006

(54) Method for forming resist pattern and resist pattern

(76) Inventors: Naotaka Kubota, Kawasaki-shi (JP); Kiyoshi Ishikawa, Kawasaki-shi (JP); Mitsuru Sato, Kawasaki-shi (JP); Tasuku Matsumiya, Kawasaki-shi (JP); Kazuhiro Fujii, Hitachinaka-shi (JP); Kenichi Sato, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/537,162

(22) PCT Filed: Dec. 2, 2003
(86) PCT No.: PCT/JP03/15427

§ 371 Date: Jan. 5, 2006

(30) Foreign Application Priority Data
Dec. 2, 2002 (JP) 2002-350465
May 28, 2003 (JP) 2003-151574

(51) Int. Cl. G03C 1/76

(52) U.S. Cl. 430/270.1

(57) ABSTRACT

A resist pattern forming method which can prevent a fine resist pattern from collapsing in a drying step after a development treatment in case of forming a resist pattern is provided. This method comprises applying a positive resist composition comprising a resin component (A), which has an alkali-soluble unit content of less than 20 mol % and also has an acid dissociable dissolution inhibiting group, alkali solubility thereof being enhanced by action of acid, an acid generator component (B) which generates an acid under exposure, and an organic solvent (C) which dissolves the components (A) and (B) on a substrate; subjecting the resulting film to prebaking, selective exposure, post exposure baking and alkali development; performing a displacing step of displacing a liquid existing on the substrate with a displacing liquid at least one time; displacing the displacing liquid with a liquid for critical drying; and performing a drying step of drying the liquid for critical drying via a critical state.

### TECHNICAL FIELD

The present invention relates to a resist pattern forming method comprising a critical drying step, and a resist pattern obtained by the method.

### BACKGROUND ART

(Patent Document 1)

Japanese Patent Application, First Publication No. Hei 1-220828, page 4, upper right column

(Patent Document 2)

Japanese Patent Application, First Publication No. Hei 9-82629, [0024], [0026]

Patent Document 1 describes that a developing action, a resist removing action and a foreign matter cleaning action are obtained by dipping a substrate in a supercritical fluid after a post-exposure treatment.

Patent Document 2 describes a method wherein a developing solution remaining after a development treatment or a rinsing liquid remaining after a development and a rinsing treatment is displaced by an inert fluorine liquid, and then the surface is dried with a nitrogen blower.

Background art of the present invention will now be described.

In the production of fine structures in various devices such as semiconductor devices, a lithography method has been widely used. Concurrent with a trend of reducing the size of the device structure, reducing of the size of the resist pattern in the lithography process has also been required.

Presently a fine pattern having a line width of 0.20 μm or less is sometimes formed by the lithography method, and also a fine pattern having high thickness and low line width, that is, a fine pattern having remarkably high aspect ratio (height/width of resist pattern) is sometimes required.

However, fine resist patterns and resist patterns having remarkably high aspect ratio had a problem that they collapse in the step after the development treatment.

To solve such a problem of pattern collapse, Patent Document 3 describes a method which employs a critical drying method proposed based on the finding that, when a liquid level of a rinsing liquid collected between resist patterns is lower than the level of the surface of the resist pattern during drying after rinsing, an attractive force is applied to the resist pattern due to a surface tension of the rinsing liquid, thus causing pattern collapse.

That is, the document describes a method for preventing surface tension from being applyed to the resist pattern during drying of the rinsing liquid, the method comprising forming a resist film made of polymethyl methacrylate (PMMA) on a substrate, exposing the resist film to X-rays to form a desired pattern, developing with an organic solvent developing solution comprising a mixed solution of methyl isobutyl ketone (MIBK) and isopropyl alcohol (IPA), dipping the entire substrate in IPA to thereby rinse the substrate, displacing IPA remaining on the substrate with liquid CO₂, and converting liquid CO₂ into a gas via a critical state.

(Patent Document 3)

Japanese Patent Application, First Publication No. Hei 5-315241, [0022] to [0031]

With recent development of a novel resist material, there is a tendency that an aqueous alkali solution is used as the developer solution and pure water is used as the rinsing liquid.

However, even if the method described in Patent Document 3 is applied to the drying step after rinsing with pure water, water collected between resist patterns on the substrate remains and is not removed, thus causing a problem that surface tension is applied to the resist pattern during drying, resulting in pattern collapse.

Even if water rinsing is omitted, since water in the aqueous alkali solution serving as a developer solution exerts the same action, a similar problem occurs.

### DISCLOSURE OF THE INVENTION

It is therefore an object of the present invention to provide a resist pattern forming method, which can prevent a resist pattern from collapsing during the step of drying after rinsing with pure water or during the step of drying an alkali developer solution remaining on a substrate in case of omitting a water rinsing, and a resist pattern obtained by the method.

To achieve the object described above, the resist pattern forming method of the present invention comprises applying a positive resist composition comprising a resin component (A), which has an alkali-soluble unit content of less than 20 mol % and also has an acid dissociable dissolution inhibiting group, alkali solubility thereof being enhanced by action of an acid, acid generator component (B) which generates an acid under exposure, and an organic solvent (C) which dissolves the components (A) and (B) on a substrate; subjecting the resulting film to prebaking, selective exposure, exposure post baking and alkali development; performing a displacing step of displacing a liquid existing on the substrate with a displacing liquid at least one time; displacing the displacing liquid with a liquid for critical drying; and performing a drying step of drying the liquid for critical drying via a critical state.

The “exposure” may include irradiation with an electron beam.

The present invention also provides a resist pattern obtained by the resist pattern forming method of the present invention.

The resist pattern of the present invention is preferably a resist pattern which has a line width of 20 to 130 nm, an aspect ratio of 2.0 to 10.0 and a pitch of 40 to 300 nm.

According to the method of the present invention, it is made possible to prevent a fine resist pattern from collapsing during a drying step after a development treatment, and to form resist patterns having good shape reliably.

### BRIEF DESCRIPTION OF THE DRAWINGS

FIG. 1 is a schematic view for explaining a drying step according to the present invention wherein a resist pattern is dried via a critical state of a liquid for critical drying.

### BEST MODE FOR CARRYING OUT THE INVENTION

The present invention will now be described in detail.

[Positive Resist Composition]

The positive resist composition of the present invention is a positive resist composition used in a resist pattern forming method comprising performing an alkali development with or without thereafter water rinsing in a lithography process, performing a displacing step of displacing a liquid existing on a substrate with a displacing liquid, displacing the displacing liquid with a liquid for critical drying, and drying the liquid for critical drying via a critical state.

The positive resist composition of the present invention contains a resin component (A), which has an alkali-soluble unit content of less than 20 mol % and also has an acid dissociable dissolution inhibiting group, alkali solubility thereof being enhanced by an action of an acid, an acid generator component (B) which generates an acid under exposure, and an organic solvent (C) which dissolves the components (A) and (B).

In such a positive resist composition, when an action of the acid generated by the component (B) is exerted, the acid dissociable dissolution inhibiting group contained in the component (A) is dissociated, and thus the entire component (A), which is insoluble in an alkali, becomes soluble in an alkali.

Therefore, when a positive resist composition applied on a substrate in the formation of a resist pattern is selectively exposed using a mask pattern, alkali solubility of the exposed area increases, and thus alkali development can be attained.

As the positive resist composition of the present invention, for example, there can be preferably used a positive resist composition for ArF proposed as a resist material suited for a method of exposing using an ArF excimer laser, or a positive resist composition for KrF proposed as a resist material suited for a method of exposing using a KrF excimer laser, the content of the alkali-soluble unit thereof being within the above range.

The resin component (A) of the positive resist composition for KrF includes a constituent unit derived from hydroxystyrene, a constituent unit composed of hydroxystyrene wherein a hydroxyl group is displaced with an acid dissociable dissolution inhibiting group and/or a constituent unit derived from a (meth)acrylate ester having an acid dissociable dissolution inhibiting group, and the resin component (A) of the positive resist composition for ArF generally includes a resin having a constituent unit derived from a (meth)acrylate ester having an acid dissociable dissolution inhibiting group in the main chain.

As used herein, the term “(meth)acrylate” refers to either or both of methacrylate and acrylate. The term “constituent unit” means a monomer unit constituting a polymer.

The alkali-soluble unit in the present invention is a constituent unit having a phenolic hydroxyl group or a carboxyl group and includes, for example, a unit derived from hydroxystyrene represented by the following [Chemical Formula 1], a unit derived from acrylic acid represented by the following [Chemical Formula 2] and a unit derived from methacrylic acid represented by the following [Chemical Formula 3]. The alcoholic hydroxyl group does not constitute an alkali-soluble unit in the present invention. 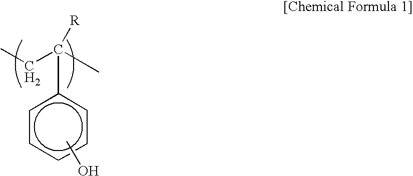
wherein R is a hydrogen atom or a methyl group

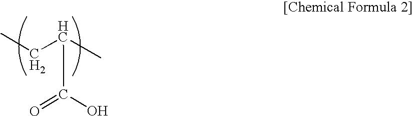

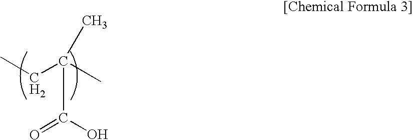

In the present invention, when the content of the alkali-soluble unit in the component (A) exceeds 20 mol %, defects of a resist pattern, for example, surface roughness, thickness loss and exfoliation from the substrate are likely to occur in the displacing step. It is considered that these defects occur because the resist pattern is corroded with a displacing liquid in the displacing step after the development treatment.

The content of the alkali-soluble unit in the component (A) is preferably 10 mol % or less, and preferably 5 mol % or less, and most preferably zero.

[Resin Component (A)]

In the positive resist composition of the present invention, the component (A) may comprise plural monomer units each having a different function, for example, a combination of the following constituent units:

a constituent unit having an acid dissociable dissolution inhibiting group (hereinafter referred to at times as a first constituent unit or (a1)),

a constituent unit including a lactone unit (hereinafter referred to at times as a second constituent unit or (a2)),

a constituent unit having an alcoholic hydroxyl group-containing polycyclic group (hereinafter referred to at times as a third constituent unit or (a3)), and

a constituent unit having a polycyclic group which is different from the acid dissociable dissolution inhibiting group of the first constituent unit, the lactone unit of the second constituent unit and the alcoholic hydroxyl group-containing polycyclic group of the third constituent unit (hereinafter referred to at times as a fourth constituent unit or (a4)).

As used herein, the term “lactone unit” refers to a group wherein one hydrogen atom is eliminated from monocyclic or polycyclic lactone.

The constituent unit (a1) is essential and the constituent units (a2) to (a4) can be appropriately used in combination according to properties required.

The constituent unit (a1) and either of the constituent units (a2) and (a3) may be used in combination. A component containing all constituent units (a1), (a2) and (a3) is preferable because it is excellent in dissolution resistance to the displacing liquid and is also excellent in etching resistance, resolution, and adhesion between the resist film and the substrate. These three constituent units preferably account for at least 80 mol %, more preferably at least 90 mol %, of the component (A).

It is preferable that the component (A) contains constituent unit (a4) because resolution from an ISO pattern to a semidense pattern (line-and-space pattern having a space width of 1.2 to 2 relative to a line width of 1) is excellent when the constituent unit (a4) is included.

Plural constituent units may be used in combination with respect to the constituent units (a1) to (a4).

[First Constituent Unit (a1)]

The first constituent unit (a1) of the component (A) may be a constituent unit derived from a (meth)acrylate ester having an acid dissociable dissolution inhibiting group, or a constituent unit derived from hydroxystyrene in which a hydroxyl group is substituted with an acid dissociable dissolution inhibiting group.

The acid dissociable dissolution inhibiting group in the constituent unit (a1) is not specifically limited as long as it has alkali dissolution inhibiting properties capable of making the entire component (A) insoluble in an alkali before exposure, and is dissociated due to an action of an acid generated from the component (B), thereby making the entire component (A) soluble in an alkali after exposure. In general, a group which forms a cyclic or chain tertiary alkyl ester with a carboxyl group of (meth)acrylic acid or a hydroxyl group of hydroxystyrene, a tertiary alkoxycarbonyl group, or a chain alkoxyalkyl group is widely known.

As the constituent unit (a1), for example, there can be preferably used a constituent unit which has an acid dissociable dissolution inhibiting group having a polycyclic group and which is also derived from a (meth)acrylate ester.

The polycyclic group includes, for example, a group in which one hydrogen atom is eliminated from bicycloalkane, tricycloalkane or tetracycloalkane. Specific examples thereof include a group in which one hydrogen atom is eliminated from polycycloalkane such as adamantane, norbornane, isobornane, tricyclodecane or tetracyclododecane. Such a polycyclic group is appropriately selected from various polycyclic groups proposed for an ArF resist. Among these polycyclic groups, an adamanthyl group, a norbornyl group and a tetracyclododecanyl group are preferable because they are readily industrially available.

As the constituent unit (a1), for example, there can be preferably used a constituent unit derived from hydroxystyrene in which a hydroxyl group is substituted with an acid dissociable dissolution inhibiting group.

Monomer units suited for use as the first constituent unit (a1) include those represented by the following [Chemical Formula 4] to [Chemical Formula 17]: 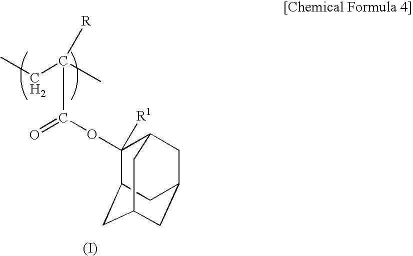
wherein R represents a hydrogen atom or a methyl group, and R¹ represents a lower alkyl group, 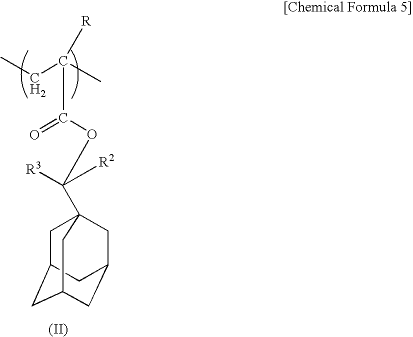
wherein R represents a hydrogen atom or methyl group, and R² and R³ each independently represents a lower alkyl group, 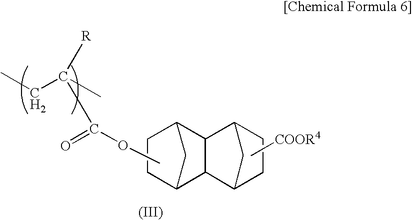
wherein R represents a hydrogen atom or a methyl group, and R⁴ represents a tertiary alkyl group, 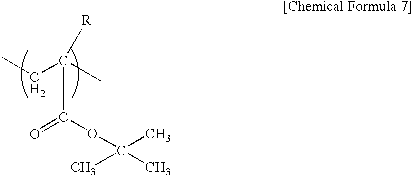
wherein R represents a hydrogen atom or a methyl group, 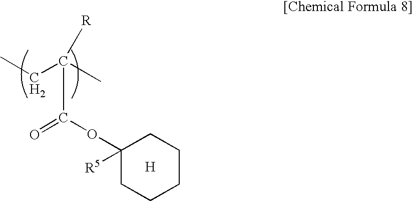
wherein R represents a hydrogen atom or a methyl group, and R⁵ represents a methyl group, 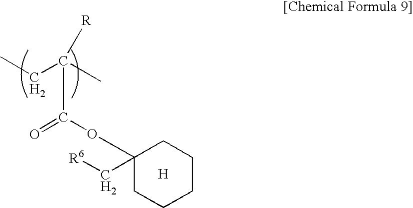
wherein R represents a hydrogen atom or a methyl group, and R⁶ represents a lower alkyl group, 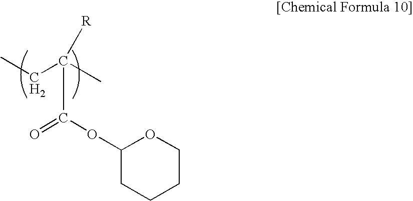
wherein R represents a hydrogen atom or a methyl group, 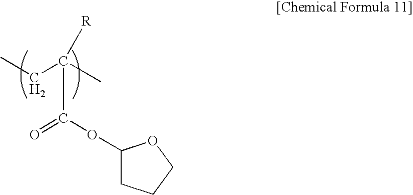
wherein R represents a hydrogen atom or a methyl group, 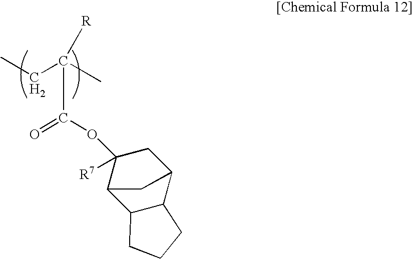
wherein R represents a hydrogen atom or a methyl group, and R⁷ represents a lower alkyl group, 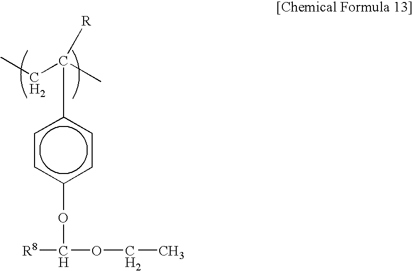
wherein R represents a hydrogen atom or a methyl group, and R⁸ represents a lower alkyl group, 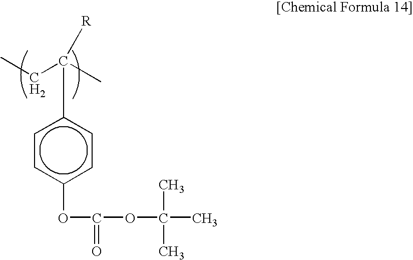
wherein R represents a hydrogen atom or a methyl group, 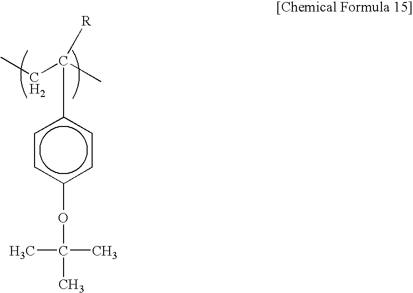
wherein R represents a hydrogen atom or a methyl group, 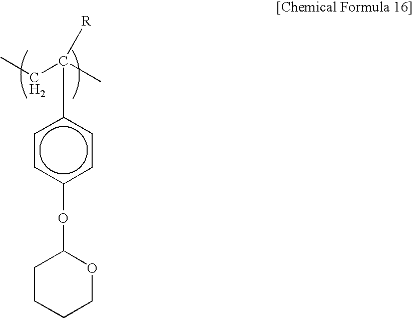
wherein R represents a hydrogen atom or a methyl group, and 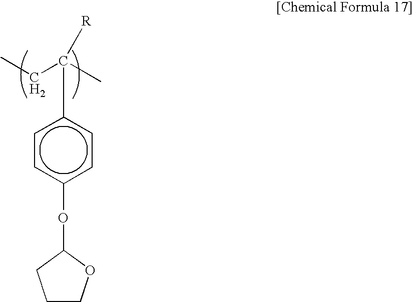
wherein R represents a hydrogen atom or a methyl group.

R¹ to R³ and R⁶ to R⁸ are preferably lower straight-chain or branched alkyl groups having 1 to 5 carbon atoms, and examples thereof include a methyl group, an ethyl group, a propyl group, an isopropyl group, an n-butyl group, an isobutyl group, a tert-butyl group, a pentyl group, an isopentyl group, and a neopentyl group. Among these groups, a methyl group or an ethyl group is preferable because it is readily industrially available.

R⁴ is a tertiary alkyl group such as a tert-butyl group or a tert-amyl group, and a tert-butyl group is preferable because it is readily industrially available.

Among constituent units listed for the first constituent unit (a1), constituent units represented by general formulas (I), (II) and (III) are particularly preferable because the resist pattern formed after the development treatment is less likely to be corroded by the displacing liquid used in the post process if these are used.

[Second Constituent Unit (a2)]

The second constituent unit (a2) of the component (A) has a lactone unit and is therefore effective to enhance adhesion between the resist film and the substrate as well as affinity with the developer solution.

The constituent unit (a2) in the present invention may be a constituent unit which has a lactone unit and is copolymerizable with the other constituent unit of the component (A).

The monocyclic lactone unit includes, for example, a group in which one hydrogen atom is eliminated from γ-butyrolactone. The polycyclic lactone unit includes, for example, a group in which one hydrogen atom is eliminated from a lactone-containing bicycloalkane.

As the constituent unit (a2), for example, there can be preferably used a constituent unit which contains a lactone unit and is derived from a (meth)acrylate ester.

Monomer units suited for use as the second constituent unit (a2) include those represented by the following [Chemical Formula 18] to [Chemical Formula 20]: 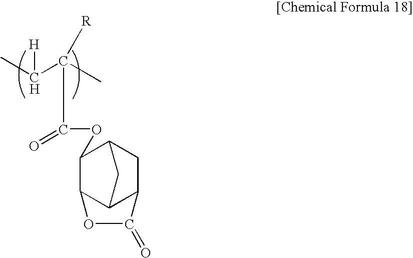
wherein R represents a hydrogen atom or a methyl group, 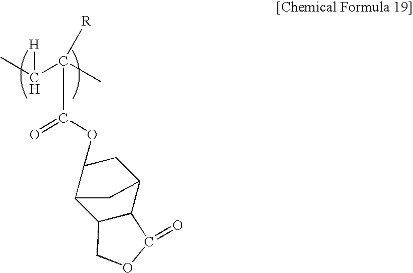
wherein R represents a hydrogen atom or methyl group, and 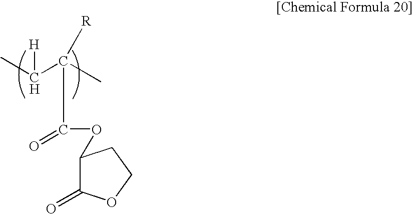
wherein R represents a hydrogen atom or a methyl group.

Among these, a γ-butyrolactone ester of (meth)acrylic acid having an ester bond at an a carbon or a norbornanelactone ester represented by [Chemical Formula 18] or [Chemical Formula 19] is preferable because it is readily industrially available.

[Third Constituent Unit (a3)]

Since the hydroxyl group in the alcoholic hydroxyl group-containing polycyclic group of the third constituent unit (a3) of the component (A) is a polar group, affinity of the entire component (A) with the developer solution is enhanced by using the hydroxyl group, and alkali solubility in the exposed area is improved. Therefore, the constituent unit (a3) contributes to an improvement in resolution.

As the polycyclic group in the constituent unit (a3), for example, there can be used those selected appropriately from the same polycyclic groups as those listed in the description of the first constituent unit (a1).

The alcoholic hydroxyl group-containing polycyclic group in the constituent unit (a3) is not specifically limited and, for example, a hydroxyl group-containing adamanthyl group is preferably used.

Furthermore, the hydroxyl group-containing adamanthyl group represented by the following general formula (IV) is preferable because it exerts the effect of enhancing dry etching resistance and enhancing rectangularity of the pattern profile: 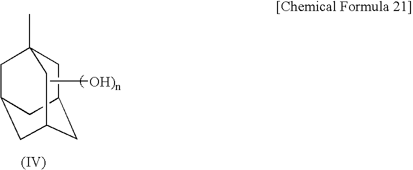
wherein n is an integer of 1 to 3.

The third constituent unit (a3) may be a constituent unit which has the above-mentioned alcoholic hydroxyl group-containing polycyclic group and is also copolymerizable with the other constituent unit of the component (A).

A constituent unit derived from a (meth)acrylate ester is particularly preferable.

Specifically, a constituent unit represented by the following general formula (IVa) is preferred: 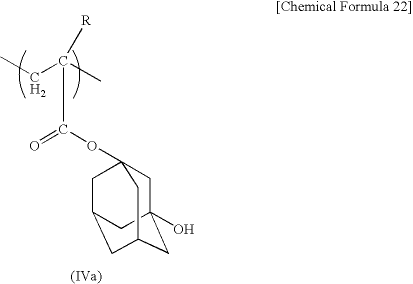
wherein R represents a hydrogen atom or a methyl group.
[Fourth Constituent Unit (a4)]

In the fourth constituent unit (a4), the polycyclic group “which is different from the acid dissociable dissolution inhibiting group, the lactone unit and the alcoholic hydroxyl group-containing polycyclic group” means that, in the component (A), the polycyclic group of the constituent unit (a4) is a polycyclic group which is not the same as any of the acid dissociable dissolution inhibiting group of the first constituent unit, the lactone unit of the second constituent unit and the alcoholic hydroxyl group-containing polycyclic group of the third constituent unit, and means that the constituent unit (a4) does not have any of the acid dissociable dissolution inhibiting group of the first constituent unit, the lactone unit of the second constituent unit and the alcoholic hydroxyl group-containing polycyclic group of the third constituent unit, each unit constituting the component (A).

The polycyclic group in the constituent unit (a4) may be selected so that it is not the same as any of the constituent units used as the constituent units (a1) to (a3) in one component (A). As the polycyclic group in the constituent unit (a4), for example, similar polycyclic group as that listed for the constituent unit (a1) can be used, and there can be used those which are conventionally known for an ArF positive resist material.

At least one selected from a tricyclodecanyl group, an adamanthyl group and a tetracyclododecanyl group is particularly preferable because it is readily industrially available.

The constituent unit (a4) may be a constituent unit which has the above-mentioned polycyclic group and is also copolymerizable with the other constituent units of the component (A).

Preferable examples of the constituent unit (a4) include those represented by the following [Chemical Formula 23] to [Chemical Formula 25]: 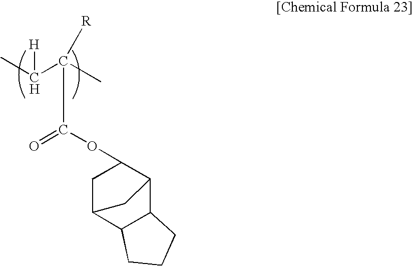
wherein R represents a hydrogen atom or a methyl group, 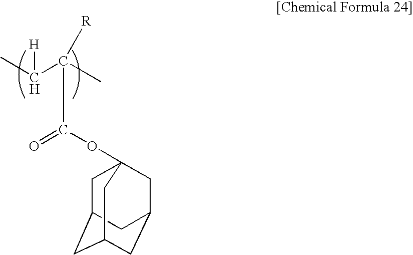
wherein R represents a hydrogen atom or a methyl group, and 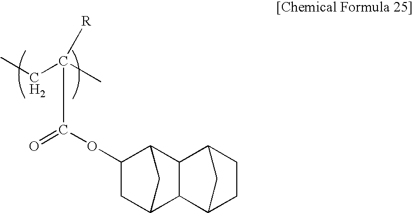
wherein R represents a hydrogen atom or a methyl group.

In the present invention, regarding the composition of the component (A), the content of the first constituent unit (a1) is from 20 to 60 mol %, and preferably from 30 to 50 mol %, based on the total of constituent units constituting the component (A), because resolution is excellent in this case.

The content of the second constituent unit (a2) is from 20 to 60 mol %, and preferably from 30 to 50 mol %, based on the total of constituent units constituting the component (A), because resolution is excellent in this case.

The content of the third constituent unit (a3) is from 5 to 50 mol %, and preferably from 10 to 40 mol %, based on the total of constituent units constituting the component (A), because resist pattern shape is excellent in this case.

When the fourth constituent unit (a4) is used, the content is from 1 to 30 mol %, and preferably from 5 to 20 mol %, based on the total of constituent units constituting the component (A), because resolution from an ISO pattern to a semidense pattern is excellent in resolution.

The weight average molecular weight (polystyrene equivalent weight average molecular weight, the same shall apply hereinafter) of the resin component (A) in the present invention is not specifically limited, and is from 5000 to 30000, and preferably from 8000 to 20000. When the weight average molecular weight is more than the above range, solubility in a resist solvent becomes worse. On the other hand, when the weight average molecular weight is less than the above range, the resist pattern profile may become worse.

The resin component (A) in the present invention can be easily prepared by copolymerizing monomers corresponding to constituent units, for example, the constituent unit (a1) as an essential component, and the constituent units (a2), (a3) and/or (a4) by means of known radical polymerization using a radical polymerization initiator such as azobisisobutyronitrile (AIBN). It is particularly preferable that the resin component (A) contains, as the constituent unit (a1), at least one constituent unit selected from those represented by general formulas (I) to (III).

To adjust the content of the alkali-soluble unit in the component (A) to less than 20 mol %, the content of the monomer having the alkali-soluble unit is adjusted to less than 20 mol % based on the entire monomer to be copolymerized.

[Acid Generator Component (B)]

In the present invention, as the acid generator component (B), there can be used an acid generator selected appropriately from those which are conventionally known as acid generators in chemically amplified resists.

Examples of the acid generator include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Among these acid generators, an onium salt containing a fluorinated alkylsulfonic acid ion as an anion is preferable.

These acid generators may be used alone or in combination as the component (B).

The amount of the component (B) is from 0.5 to 30 parts by weight, and preferably from 1 to 10 parts by weight, based on 100 parts by weight of the component (A). When the amount is less than 0.5 parts by weight, a pattern is not formed satisfactorily. On the other hand, when the amount exceeds 30 parts by weight, a uniform solution is not obtained with ease and storage stability may be lowered.

[Organic Solvent (C)]

The positive resist composition of the present invention can be prepared by dissolving the above-mentioned component (A), the above-mentioned component (B) and an optional component (D) described hereinafter in an organic solvent (C).

The organic solvent (C) may be any solvent which can uniformly dissolve the components (A) and (B) to give a uniform solution, and there can be used at least one solvent selected appropriately from those which are conventionally been known as solvents of chemically amplified resists.

Examples of the organic solvent (C) include ketones such as acetone, methyl ethyl ketone, cyclohexanone, methyl isoamyl ketone, and 2-heptanone; polyhydric alcohols and derivatives thereof, such as ethylene glycol, ethylene glycol monoacetate, diethylene glycol, diethylene glycol monoacetate, propylene glycol, propylene glycol monoacetate, dipropylene glycol, and monomethyl ether, monoethyl ether, monopropyl ether, monobutyl ether and monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents may be used alone, or a solvent mixture of two or more kinds of them may be used.

A solvent mixture of propylene glycol monomethyl ether acetate (PGMEA) and a polar solvent having a hydroxy group or lactone, such as propylene glycol monomethyl ether (PGME), ethyl lactate (EL) or γ-butyrolactone is particularly preferable because storage stability of the positive resist composition is improved. When EL is mixed, a weight ratio of PGMEA:EL is preferably from 6:4 to 4:6.

When PGME is mixed, a weight ratio of PGMEA:PGME is from 8:2 to 2:8, and preferably from 8:2 to 5:5.

When the component (A) containing all constituent units (a1) to (a4) is used, a solvent mixture of PGMEA and PGME is preferable because storage stability of the positive resist composition is improved in this case.

As the component (C), a solvent mixture of at least one selected from PGMEA and ethyl lactate and γ-butyrolactone is also preferable. In this case, a mixing weight ratio of the former to the latter is preferably from 70:30 to 95:5.

The content of the organic solvent (C) in the positive resist composition of the present invention is appropriately set according to the thickness of the resist film so that the solid content of the resist composition is within a range of 3 to 30% by weight.

[Other Components]

To improve resist pattern shape and post exposure stability of the latent image formed by the pattern wise exposure of the resist layer, the positive resist composition of the present invention may further contain a secondary lower aliphatic amine or a tertiary lower aliphatic amine as an optional component (D).

As used herein, the lower aliphatic amine refers to an amine of an alkyl or alkyl alcohol having 5 or less carbon atoms. Examples of the secondary and tertiary amines include trimethylamine, diethylamine, triethylamine, di-n-propylamine, tri-n-propylamine, tripentylamine, diethanolamine, and triethanolamine, and alkanolamine such as triethanolamine is particularly preferable.

These amines may be used alone or in combination.

The content of these amines is normally within a range from 0.01 to 1.0% by weight based on the component (A).

If necessary, the positive resist composition of the present invention contains miscible additives, for example, additive resins for improving performance of the resist film, surfactants for improving coatability, dissolution inhibitors, plasticizers, stabilizers, colorants and antihalation agents.

[Pattern Forming Method]

The pattern forming method of the present invention will now be described.

First, a positive resist composition of the present invention is applied on a substrate such as a silicon wafer using a spinner, and then prebaked. Using an aligner, a coating film of the positive resist composition is selectively exposed and then subjected to PEB (post exposure baking). This selective exposure also includes exposure to exposure light via a mask pattern, irradiation with electron beam using a mask pattern, or electron beam lithography without using a mask pattern. Subsequently, a development treatment is performed using an alkali developer solution comprising an aqueous alkali solution and water rinsing is performed using pure water. In the water rinsing, for example, water is dropped or sprayed on the surface of a substrate while rotating the substrate, thereby washing away the developer solution on the substrate and the resist composition dissolved with the developer solution. Consequently, the coating film of the positive resist composition is patterned in a shape corresponding to the mask pattern to obtain an undried resist pattern.

The above-mentioned steps can be performed by a well-known procedure. The operation conditions are preferably set according to the composition and properties of the positive resist composition to be used.

The light source having a specific wavelength used for exposure is not specifically limited and exposure can be performed by using radiation sources such as an ArF excimer laser, a KrF excimer laser, an F2 excimer laser, an EUV (extreme ultraviolet ray), a VUV (vacuum ultraviolet ray), an electron beam, an X-ray, or a soft X-ray. The positive resist composition of the present invention is particularly useful for KrF excimer laser, ArF excimer laser or electron beam.

Furthermore, an organic or inorganic anti-reflection film can be provided between the substrate and the coating film of the resist composition.

Although water rinsing after the development treatment can be omitted, an alkali component in the alkali developer solution is preferably washed away by the water rinsing step. The present invention will now be described with reference to the embodiment in which the water rinsing step is performed.

After the water rinsing is completed, the substrate is subjected to a subsequent step in the state where the undried resist pattern is completely dipped in pure water.

In the displacing step, the operation of displacing a liquid existing on the substrate, for example, water in this embodiment, with a displacing liquid is performed once or pmultiple times, and thus the undried resist pattern on the substrate is completely dipped in the displacing liquid. The operating method of displacing the liquid on the substrate with the displacing liquid is not specifically limited and, for example, there can be used a method of dipping a substrate in a displacing liquid or a method of spraying a displacing liquid over a substrate.

In the displacing step, first, a liquid on a substrate is displaced with a first displacing liquid, and then the first displacing liquid is displaced with a second displacing liquid, and thus the undried resist pattern on the substrate may be completely dipped in the second displacing liquid.

In the displacing step after water rinsing, the operation of displacing the liquid on the substrate with the displacing liquid is preferably performed at least two times so as to sufficiently remove the liquid on the substrate.

The displacing liquid in the present invention is not specifically limited as long as it is an inert liquid which does not react with the undried resist pattern and is capable of displacing the liquid on the substrate, and also can be displaced with a liquid for critical drying in the present invention. A displacing liquid containing a surfactant is more preferable because the liquid can be efficiently displaced by it.

As the displacing liquid, an inert fluorine liquid is preferably used. Specific examples of the inert fluorine liquid include liquids containing fluorine compounds such as C₃HCl₂F₅, C₄F₉OCH₃, C₄F₉OC₂H₅, C₅H₃F₇, C₅H₂F₁₀ and C₂H₃Cl₂F as a main component. Inert fluorine liquids prepared by mixing these fluorine compounds with alcohols such as isopropyl alcohol, methanol or ethanol are also preferable.

As described above, in case two-stage displacement is performed using the first displacing liquid and the second displacing liquid, it is preferred to use a liquid containing a surfactant as the first displacing liquid and to use a liquid containing no surfactant as the second displacing liquid because the surfactant is not left on the substrate after the displacing step is completed in this case.

The use of the liquid containing a surfactant as the first displacing liquid is effective when a fine pattern is formed, particularly a fine pattern is formed by exposure to electron beam.

After the displacing step is completed, the substrate is subjected to the subsequent drying step in the state where the undried resist pattern is completely dipped in the displacing liquid.

In the drying step, first, a displacing liquid on the substrate is displaced with a liquid for critical drying. As the liquid for critical drying, there can be used a fluid which can be converted into a liquid phase when the displacing liquid is displaced, for example, a liquefied gas obtained by liquefying a substance, which is in a gas phase at normal temperature under normal pressure (e.g. carbon dioxide), by appropriately adjusting the temperature and pressure on displacement.

As the liquid for critical drying, there can be preferably used a fluid which has a critical temperature of 0° C. or higher and a critical pressure of 30 MPa or less. Specific examples thereof include CO₂, H₂O, C₃H₆, N₂O, and CHF₃. The critical temperatures (hereinafter referred to at times as Tc) and the critical pressures (hereinafter referred to at times as Pc) of these fluids are as follows:

CO₂: Tc=31.1° C., Pc=about 7.38 MPa (72.8 atm),

H₂O: Tc=374° C., Pc=about 22.0 MPa (217.6 atm),

C₃H₆: Tc=92.3° C., Pc=about 4.6 MPa (45.6 atm),

N₂O: Tc=36.5° C., Pc=about 7.27 MPa (71.7 atm), and

CHF₃: Tc=25.9° C., Pc=about 48.4 MPa (47.8 atm).

Among these fluids, carbon dioxide is preferable in view of industrial applicability.

The present invention will be described by reference to an embodiment in which liquid CO₂ is used as the liquid for critical drying.

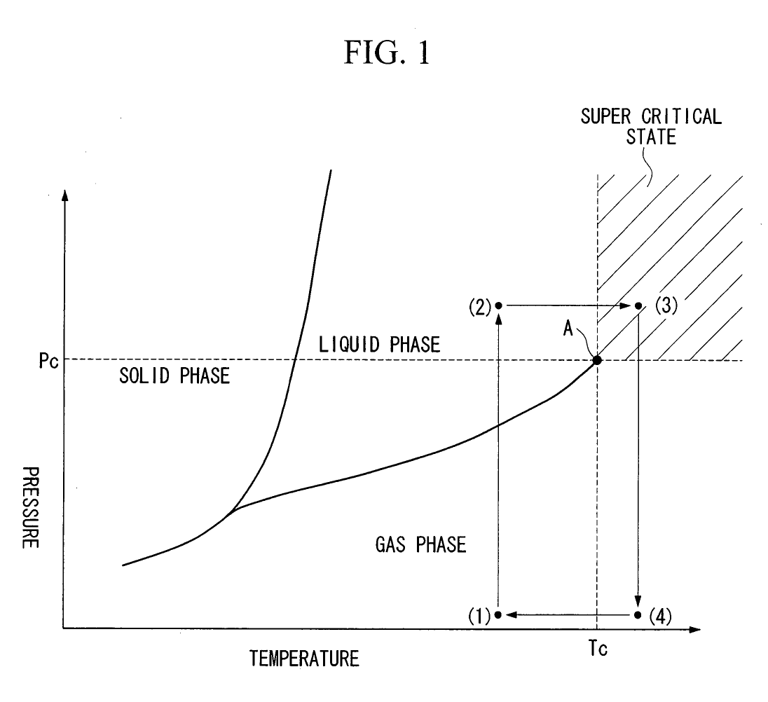

FIG. 1 is a schematic view showing a gas-liquid equilibrium curve of a fluid. In the drawing, the point A denotes a critical point, and is a point where Tc=31.1° C., and Pc=7.38 MPa in the case of carbon dioxide.

The method of displacing the displacing liquid on the substrate with the liquid for critical drying is not specifically limited. When liquid CO₂ is used, the substrate, which has been subjected to the displacing step, is placed in a pressure vessel capable of being pressurized in the state where the resist pattern is dipped in the displacing liquid. The temperature and pressure in the pressure vessel are normally room temperature and atmospheric pressure (point (1) in FIG. 1). Subsequently, liquid CO₂ is supplied to the pressure vessel and the pressure vessel is filled with liquid CO₂ under conditions of temperature and pressure in the pressure vessel so as to convert the CO₂ into a liquid phase (for example, point (2) in FIG. 1). Then, the displacing liquid on the substrate is displaced with the liquid for critical drying (liquid CO₂) by allowing liquid CO₂ mixed with the displacing liquid to flow out of the pressure vessel while supplying liquid CO₂ to the pressure vessel in a state of maintaining the temperature and pressure in the pressure vessel.

Subsequently, the liquid for critical drying is dried through a critical state. Specifically, after adjusting the temperature and pressure in the pressure vessel so as to bring the liquid for critical drying to a supercritical state (for example, point (3) in FIG. 1), the liquid for critical drying in a supercritical state is allowed to flow out of the pressure vessel while maintaining the temperature. Consequently, the pressure of the liquid for critical drying decreases, for example, the temperature and pressure at the point (4) in the drawing are attained, and thus the liquid on the substrate is removed in the state of a gas phase and then dried. If necessary, the atmosphere in the pressure vessel is cooled to room temperature.

When liquid CO₂ is used as the liquid for critical drying, the displacing liquid on the substrate is displaced with the liquid CO₂ and the temperature and pressure in the pressure vessel are adjusted to 31.1° C. or higher and 7.38 MPa or higher, thereby to bring the CO₂ to a supercritical state. When the CO₂ is gradually leaked while maintaining the temperature at 31.1° C. or higher, the pressure in the pressure vessel decreases to lower than 7.38 MPa and finally decreased to an atmospheric pressure. Consequently, the CO₂ in the supercritical state is converted into a gas phase and the substrate is in a dry state. Furthermore, when the temperature in the pressure vessel is decreased to about room temperature, thereby to terminate the drying step, a dried resist pattern is obtained.

When the liquid for critical drying is brought to a critical state, it is preferably brought to a supercritical state by adjusting the temperature to a critical temperature or higher and adjusting the pressure to a critical pressure or higher. Even when the fluid is brought to a subcritical state close to the supercritical state, by adjusting the temperature to lower than a critical temperature and adjusting the pressure to lower than a critical pressure, the liquid on the substrate can be removed.

By forming a resist pattern in such a manner, resist pattern collapse during the drying step can be prevented even in case of a resist pattern having a shape, which is likely to collapse, such as a resist pattern having a small line width, or a resist pattern having a high aspect ratio, particularly a line-and-space pattern having a small pitch which is likely to cause pattern collapse.

As used herein, the pitch in the line-and-space pattern refers to a total distance of a resist pattern width and a space width of the pattern in a line width.

Even if water rinsing is omitted, the same displacing and drying steps can be applied in the step of drying the developer solution (aqueous alkali solution) on the substrate after the development treatment, thereby making it possible to prevent resist pattern collapse.

Furthermore, since the resist pattern is made of a resist composition of the present invention in which the content of the alkali-soluble unit in the resin component (A) is less than 20 mol %, defects such as surface roughness, thickness loss and exfoliation from the substrate do not occur even if the undried resist pattern is contacted with the displacing liquid, and thus a resist pattern having high shape accuracy can be obtained reliably.

The resist pattern to be formed by the method of the present invention is a high-density line-and-space pattern which has a line width of 20 to 130 nm, preferably 30 to 100 nm, an aspect ratio of 2.0 to 10.0, preferably 2.5 to 8.0, and a pitch of 40 to 300 nm, preferably 50 to 260 nm.

When the line width exceeds the above range, the resist pattern can be formed by a conventional method. On the other hand, when the line width is smaller than the above range, it becomes difficult to form a resist pattern.

When the aspect ratio is smaller than the above range, the resist pattern can be formed by a conventional method. On the other hand, when the aspect ratio exceeds the above range, it becomes difficult to form a resist pattern.

When the pitch exceeds the above range, the resist pattern can be formed by a conventional method. On the other hand, when the pitch is smaller than the above range, it becomes difficult to form a resist pattern.

When a critical drying step is used and an electron beam is used for exposure, a finer resist pattern and a resist pattern having a higher aspect ratio can be realized. For example, a fine line-and-space pattern having a line width of 20 to 100 nm, preferably 20 to 80 nm, and an aspect ratio of about 2.0 to 10.0 can be formed without causing pattern collapse.

### EXAMPLES

The present invention will now be described in detail by way of examples.

### Example 1

The following components (A), (B) and (D) were uniformly dissolved in the component (C) to prepare a positive resist composition.

As the component (A), 100 parts by weight of an acrylic acid ester copolymer comprising three kinds of constituent units represented by [Chemical Formula 26] was used. The contents of the constituent units p, q and r used to prepare the component (A) were 40 mol %, 40 mol % and 20 mol %, respectively. The content of the alkali-soluble unit in the component (A) was 0 mol % and the weight average molecular weight of the component (A) was 10,000.

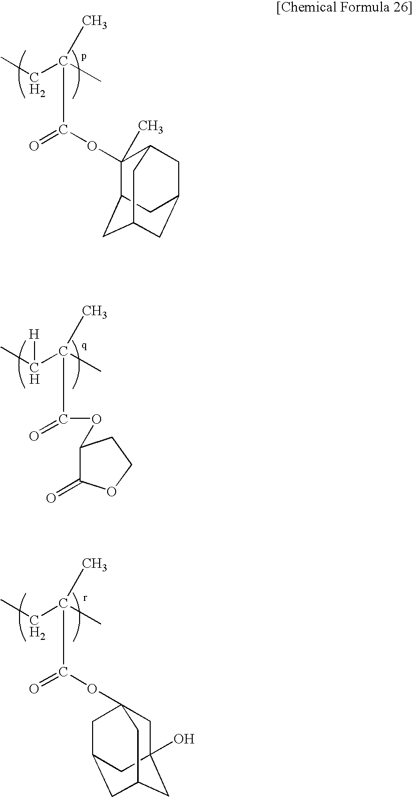

As the component (B), 2.0 parts by weight of triphenylsulfonium nonafluorobutanesulfonate and 0.6 parts by weight of triphenylsulfonium trifluoromethanesulfonate were used.

As the component (C), a solvent mixture of 450 parts by weight of propylene glycol monomethyl ether acetate and 300 parts by weight of ethyl lactate was used.

As the component (D), 0.3 parts by weight of triethanolamine was used.

The resulting positive resist composition was applied on a silicon wafer using a spinner, and then dried by prebaking on a hot plate at 130° C. for 90 seconds to form a 340 nm thick resist layer.

Subsequently, the resist layer was selectively exposed to an ArF excimer laser (193 nm) using a phase shift mask and using an ArF aligner S-302 (manufactured by Nikon Corporation, NA (numerical aperture)=0.60, σ=0.40).

The resist layer was subjected to a PEB treatment under the conditions of a temperature of 130° C. for 90 seconds, paddle-developed with an alkali developer solution at 23° C. for 60 seconds, and then subjected to water rinsing with pure water for 180 seconds. As an alkali developer solution, an aqueous 2.38 wt % tetramethylammonium hydroxide solution was used.

The substrate subjected to water rinsing was dipped in a first displacing liquid, thereby to displace the liquid existing on the substrate with the first displacing liquid, and then dipped in a second displacing liquid, thereby to displace the liquid on the substrate with the second displacing liquid. As the first displacing liquid, a liquid containing an inert fluorine liquid CF₃CF₂CHCl₂ and CClF₂CF₂CHClF, as a main component, and a surfactant (manufactured by Asahi Glass Co., Ltd. under the trade name AK225DW) was used. As the second displacing liquid, a liquid containing an inert fluorine liquid as a main component (manufactured by Asahi Glass Co., Ltd. under the trade name of AK225) was used. These liquids are commercially available as a detergent for members made of metal, plastic, rubber or the like.

Then, the substrate was critically dried by using a Fine Structure Drying Unit (Model SRD-2020, manufactured by Hitachi Science Systems, Ltd.).

First, the substrate was placed in a pressure vessel. The temperature in the pressure vessel was room temperature (23° C.) and the pressure was atmospheric pressure (point (1) in FIG. 1).

Subsequently, liquid CO₂ was supplied in a pressure vessel under pressure, thereby to increase the pressure in the pressure vessel to 7.5 MPa. The temperature was maintained at 23° C. (point (2) in FIG. 1). Furthermore, the liquid on the substrate was displaced with a liquid for critical drying by allowing liquid CO₂ in the pressure vessel to flow out of the pressure vessel while supplying liquid CO₂ to the pressure vessel in a state of maintaining the temperature and pressure in the pressure vessel.

Then, CO₂ in the pressure vessel was brought to a supercritical state (point (3) in FIG. 1) by heating to 35° C. at a heating rate of 2° C./minute while maintaining the pressure in the pressure vessel at 7.5 MPa.

Subsequently, CO₂ was gradually leaked while maintaining the temperature at 35° C. or higher. Consequently, the pressure in the pressure vessel decreased to an atmospheric pressure and the CO₂ was converted into a gas phase state. (point (4) in FIG. 1).

Then, the temperature in the pressure vessel was decreased to room temperature, and thus the drying step was terminated.

On the substrate thus dried, a line-and-space resist pattern having a line width 90 nm, an aspect ratio of 3.8 and a pitch of 180 nm was formed in a good shape and pattern collapse did not occur.

### Comparative Example 1

The same operation as in Example 1 was repeated up to the water rinsing step, and draining was performed by a spin drying method of rotating a substrate and pure water remaining on the substrate was removed by heating the substrate on a hot plate at 100° C.

In the substrate thus dried, the resulting resist pattern had a good shape, however, adjacent resist patterns had collapsed with each other.

### Example 2

Example 2 was conducted in the same manner as Example 1, except that an exposure dose increased (overdose) to form a resist pattern having finer shape. As a result, a line-and-space pattern having a line width of 48 nm, an aspect ratio of 7.1 and a pitch of 180 nm was formed. The resulting resist pattern had a good shape and pattern collapse did not occur.

### Comparative Example 2

Comparative Example 2 was conducted in the same manner as in Example 1, except that the component (A) was changed to 100 parts by weight of a resin prepared by adjusting the contents of three kinds of constituent units p, q and r represented by [Chemical Formula 26] to 30 mol %, 30 mol % and 10 mol %, respectively, and mixing with 30 mol % of the constituent unit represented by [Chemical Formula 3], a resist composition was prepared.

Using the resulting resist composition, a resist pattern was formed in the same manner as in Example 1. As a result, a line-and-space pattern having a line width of 90 nm and a pitch of 180 nm caused surface roughness, thickness loss and exfoliation from the substrate when dipped in the first displacing liquid, and had a poor shape.

### Example 3

As the component (A), the same component as in Example 1 was used.

As the component (B), 6.82 parts by weight of triphenylsulfonium nonafluorobutanesulfonate was used.

As the component (C), a solvent mixture of 450 parts by weight of propylene glycol monomethyl ether acetate and 300 parts by weight of propylene glycol monomethyl ether was used.

As the component (D), 0.3 parts by weight of triethanolamine was used.

The components (A), (B) and (D), and 0.05 parts by weight of a nonionic fluorine-silicone type surfactant (manufactured by Dainippon Ink & Chemicals, Incorporated under the trade name of Magafac R-08) was uniformly dissolved in the component (C) to prepare a positive resist composition.

The resulting positive resist composition was applied on a silicon wafer treated with hexamethyldisilazane using a spinner, and then dried by prebaking on a hot plate at 150° C. for 90 seconds to form a 340 nm thick resist layer.

Then, the resist layer was selectively exposed by a lithography method of directly irradiating with an electron beam using an electron beam lithography system (HL-800D manufactured by Hitachi, Ltd., acceleration voltage: 70 kV).

The resist layer was subjected to a PEB treatment under the conditions of a temperature of 140° C. for 90 seconds, dip development of dipping in an alkali developer solution at 23° C. for 60 seconds, and water rinsing with pure water for 60 seconds. As the alkali developer solution, an aqueous 2.38 wt % tetramethylammonium hydroxide solution was used.

The substrate subjected to water rinsing was dipped in a first displacing liquid for 60 seconds, thereby to displace the liquid existing on the substrate with the first displacing liquid, and then dipped in a second displacing liquid for 60 seconds, thereby to displace the liquid on the substrate with the second displacing liquid. As the first displacing liquid and the second displacing liquid, AK225DW and AK225, which are the same as those used in Example 1), were used.

In the same manner as in Example 1, the substrate was critically dried by using a Fine Structure Drying Unit.

On the substrate thus dried, a line-and-space resist pattern having a line width 70 nm, an aspect ratio of 4.86 and a pitch of 140 nm was formed in a good shape and pattern collapse did not occur.

### Example 4

In the same manner as in Example 3, except that the first displacing liquid was changed to a liquid containing inert fluorine liquids CF₃CF₂CHCl₂ and CClF₂CF₂CHClF, as a main component, and a surfactant (manufactured by Asahi Glass Co., Ltd. under the trade name of AK225DH), a resist pattern was formed. On the substrate thus dried, a line-and-space resist pattern having a line width 70 nm, an aspect ratio of 4.86 and a pitch of 140 nm was formed in a good shape and pattern collapse did not occur.

### INDUSTRIAL APPLICABILITY

According to the present invention, it is made possible to prevent a fine resist pattern from collapsing during a drying step after a development treatment, and to form a resist pattern having good shape in good yield, and thus the present invention is remarkably useful from an industrial point of view.

1. A resist pattern forming method, which comprises applying a positive resist composition comprising a resin component (A), which has an alkali-soluble unit content of less than 20 mol % and also has an acid dissociable dissolution inhibiting group, alkali solubility thereof being enhanced by action of acid, an acid generator component (B) which generates an acid under exposure, and an organic solvent (C) which dissolves the components (A) and (B) on a substrate; subjecting the resulting film to prebaking, selective exposure, post exposure baking and alkali development; performing a displacing step of displacing a liquid existing on the substrate with a displacing liquid at least one time; displacing the displacing liquid with a liquid for critical drying; and performing a drying step of drying the liquid for critical drying via a critical state.

2. The resist pattern forming method according to claim 1, wherein the displacing step is performed after the alkali development and the subsequent water rinsing.

3. The resist pattern forming method according to claim 1, wherein, in the displacing step, an operation of displacing the liquid existing on the substrate with a displacing liquid containing a surfactant is performed at least one time.

4. The resist pattern forming method according to claim 1, wherein an inert fluorine liquid is used as the displacing liquid.

5. The resist pattern forming method according to claim 1, wherein, in the displacing step, the liquid existing on the substrate is displaced with a first displacing liquid, and furthermore, the liquid existing on the substrate is displaced with a second displacing liquid.

6. The resist pattern forming method according to claim 1, wherein the exposure is performed using a KrF excimer laser.

7. The resist pattern forming method according to claim 1, wherein the exposure is performed using an ArF excimer laser.

8. The resist pattern forming method according to claim 1, wherein the exposure is performed using an electron beam.

9. A resist pattern obtained by the resist pattern forming method according to claim 1.

10. The resist pattern according to claim 9, which has a line width of 20 to 130 m, an aspect ratio of 2.0 to 10.0 and a pitch of 40 to 300 nm.

11. A method for forming a resist pattern comprising:
providing a positive resist composition comprising:
a resin component (A), alkali solubility of which is enhanced by action of acid, and which an acid dissociable dissolution inhibiting group and has an alkali-soluble unit content of less than 20 mol %;
an acid generator component (B) which generates an acid under exposure; and
an organic solvent (C) which dissolves the components (A) and (B);
applying the positive resist composition on a substrate to form a film;
subjecting the film to prebaking, selective exposure, post exposure baking, and alkali development;
displacing at least once a liquid existing on the substrate with a displacing liquid;
displacing at least once the displacing liquid with a liquid for critical drying; and
drying the liquid for critical drying through a critical state.

12. The method according to claim 11, further comprising subjecting the film to water rinsing following the alkali development.

13. The method according to claim 11, wherein an inert fluorine liquid is used as the displacing liquid.

14. The method according to claim 11, wherein the step of displacing the liquid existing on the substrate comprises displacing the liquid with the displacing liquid used as a first displacing liquid, and further displacing the liquid with a second displacing liquid.

15. The method according to claim 11, wherein the exposure is performed using a KrF excimer laser, an ArF excimer laser, or an electron beam.
